(19) United States
(12) Patent Application Publication
(10) Pub. No.: US 2016/0205733 A1
(43) Pub. Date: Jul. 14, 2016

(54) LOW-COST DIMMING DRIVER CIRCUIT WITH IMPROVED POWER FACTOR

(71) Applicants: Timothy Chen, Aurora, OH (US); Daniel Albert Haas, Rootstown, OH (US)

(72) Inventors: Timothy Chen, Aurora, OH (US); Daniel Albert Haas, Rootstown, OH (US)

(73) Assignee: TECHNICAL CONSUMER PRODUCTS, INC., Aurora, OH (US)

(21) Appl. No.: 14/631,175

(22) Filed: Feb. 25, 2015

Related U.S. Application Data
(63) Continuation-in-part of application No. 14/594,536, filed on Jan. 12, 2015.

(51) Int. Cl. H05B 33/08; H02M 1/42

(52) U.S. Cl. CPC H05B 33/0815; H05B 33/0845; H02M 1/42

(57) ABSTRACT

A driver circuit for powering at least one light emitting diode (LED) in a dimming application is disclosed. The driver circuit includes an input for connection to a source of dimmed AC power and a rectifier for converting the dimmed AC power from the input into DC power. The driver circuit also includes a voltage bus filter for smoothening the DC power from the rectifier. The voltage bus filter includes at least one capacitor. The driver circuit also includes a feedback circuit in electrical communication with the rectifier. The feedback circuit causes the rectifier to continuously draw current from the inputs of the driver circuit.

### RELATED APPLICATIONS

This application is a continuation-in-part application of U.S. application Ser. No. 14/594,536, filed on Jan. 12, 2015.

### TECHNICAL FIELD

The present disclosure relates generally to a driver circuit for dimming a light emitting diode (LED), and more particularly to a driver circuit including a feedback circuit that causes an input rectifier to continuously draw current from inputs of the driver circuit.

### BACKGROUND

Light emitting diode (LED) based lighting systems may offer several energy and reliability advantages over other types of lighting systems such as, for example, incandescent or fluorescent lighting. Thus, LED based lighting systems may be an attractive candidate to replace other existing lighting technologies.

Historically, incandescent light bulbs have had a nearly perfect power factor (PF). In other words, incandescent bulbs typically have a PF of about 1. Those skilled in the art will readily appreciate that electrical devices having a relatively low PF require additional power from the utility, which is also referred to as grid power. Accordingly, high power factor solutions are desirable for LED based lighting systems. In particular, it may be especially desirable for an LED based lighting fixture to have a PF of at least 0.7 in order to obtain specific types of energy certifications promulgated by the United States government (e.g., the ENERGY STAR® certification). This is because some potential consumers of lighting products may make purchasing decisions based on whether or not an LED lighting fixture has obtained one or more specific types of energy certifications. Moreover, those skilled in the art will also appreciate there is also a continuing need in the art for a relatively low-cost, reliable driver for an LED lighting fixture as well.

### SUMMARY

In one embodiment, a driver circuit for powering at least one light emitting diode (LED) in a dimming application is disclosed. The driver circuit includes an input for connection to a source of dimmed AC power and a rectifier for converting the dimmed AC power from the input into DC power. The driver circuit also includes a voltage bus filter for smoothening the DC power from the rectifier. The voltage bus filter includes at least one capacitor. The driver circuit also includes a feedback circuit in electrical communication with the rectifier. The feedback circuit causes the rectifier to continuously draw current from the inputs of the driver circuit.

In another embodiment, a driver circuit for powering at least one LED in a dimming application is disclosed. The driver circuit includes an input for connection to a source of dimmed AC power and a rectifier for converting the dimmed AC power from the input into DC power. The driver circuit also includes a voltage bus filter for smoothening the DC power from the rectifier. The voltage bus filter includes at least one capacitor. The driver circuit also includes a feedback circuit in electrical communication with the rectifier, and connected to the driver circuit at a location before the rectifier. The feedback circuit causes the rectifier to continuously draw current from the inputs of the driver circuit.

In yet another embodiment, a driver circuit for powering at least one LED in a dimming application is disclosed. The driver circuit includes an input for connection to a source of dimmed AC power and a rectifier for converting the dimmed AC power from the input into DC power. The driver circuit also includes a voltage bus filter for smoothening the DC power from the rectifier. The voltage bus filter includes at least one capacitor. The driver circuit also includes a feedback circuit in electrical communication with the rectifier, and connected to the driver circuit at a location after the rectifier. The feedback circuit causes the rectifier to continuously draw current from the inputs of the driver circuit.

### BRIEF DESCRIPTION OF THE DRAWINGS

FIG. 1 is an exemplary block diagram of a circuit with an improved power factor (PF) for providing DC current to a load;

FIG. 2 is an exemplary circuit diagram of the circuit shown in FIG. 1, where a rectifier includes fast recovery diodes;

FIG. 3 is an illustration of an exemplary AC waveform at inputs of the circuit shown in FIGS. 1 and 2, as well as a rectified input voltage measured at a voltage bus filter of the circuit;

FIG. 4 is an illustration of a resonant curve and an operating point of the resonant driver shown in FIGS. 1 and 2;

FIG. 5 is an alternative embodiment of the circuit diagram shown in FIG. 2, where the rectifier does not include fast recovery diodes;

FIG. 6 is another embodiment of the circuit diagram shown in FIG. 5, where the location of a blocking capacitor is modified;

FIG. 7 is an embodiment of the circuit diagram shown in FIG. 1, where the circuit is used in a dimming application and includes a snubber circuit electrically connected to the rectifier;

FIG. 8 is an alternative embodiment of the circuit diagram shown in FIG. 7;

FIG. 9 is another embodiment of the circuit diagram shown in FIG. 7;

FIG. 10 is yet another embodiment of the circuit diagram shown in FIG. 7;

FIG. 11 is another embodiment of the circuit diagram shown in FIG. 7;

FIG. 12 is yet another embodiment of the circuit diagram shown in FIG. 7;

FIG. 13 is another embodiment of the circuit diagram shown in FIG. 7;

FIG. 14 is yet another embodiment of the circuit diagram shown in FIG. 7;

FIG. 15 is another embodiment of the circuit diagram shown in FIG. 7;

FIG. 16 is another embodiment of the circuit diagram shown in FIG. 7;

FIG. 17 is still another embodiment of the circuit diagram shown in FIG. 7; and

FIGS. 18A-18E illustrate various embodiments of the snubber circuit illustrated in FIGS. 7-17.

### DETAILED DESCRIPTION

The following detailed description will illustrate the general principles of the invention, examples of which are additionally illustrated in the accompanying drawings. In the drawings, like reference numbers indicate identical or functionally similar elements.

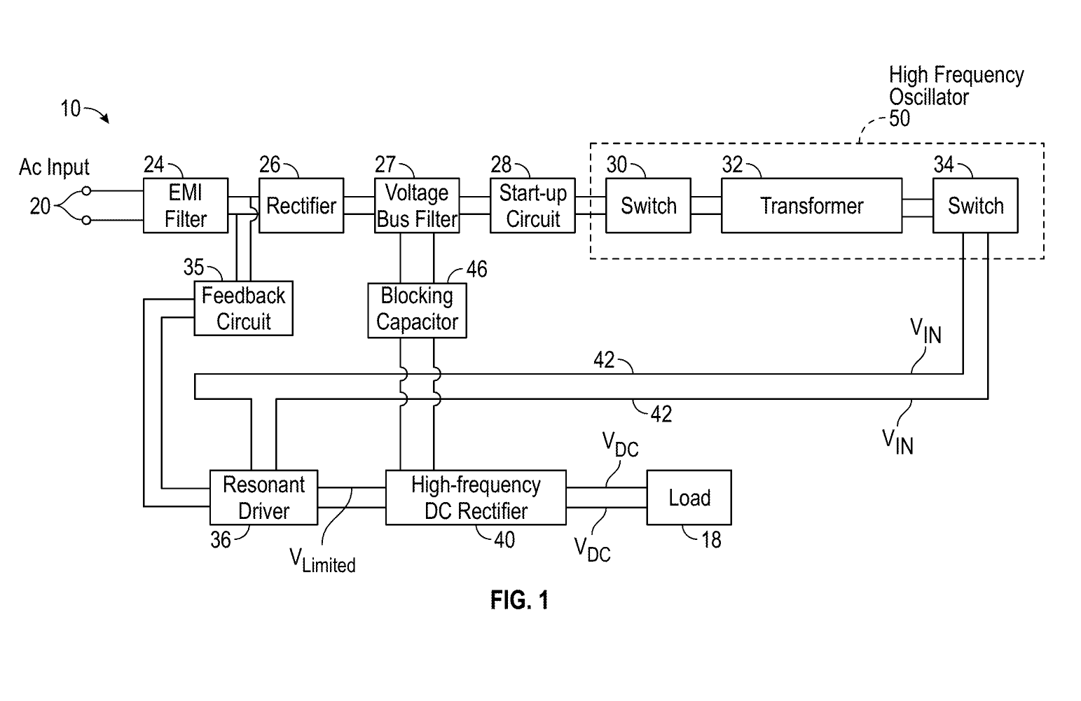

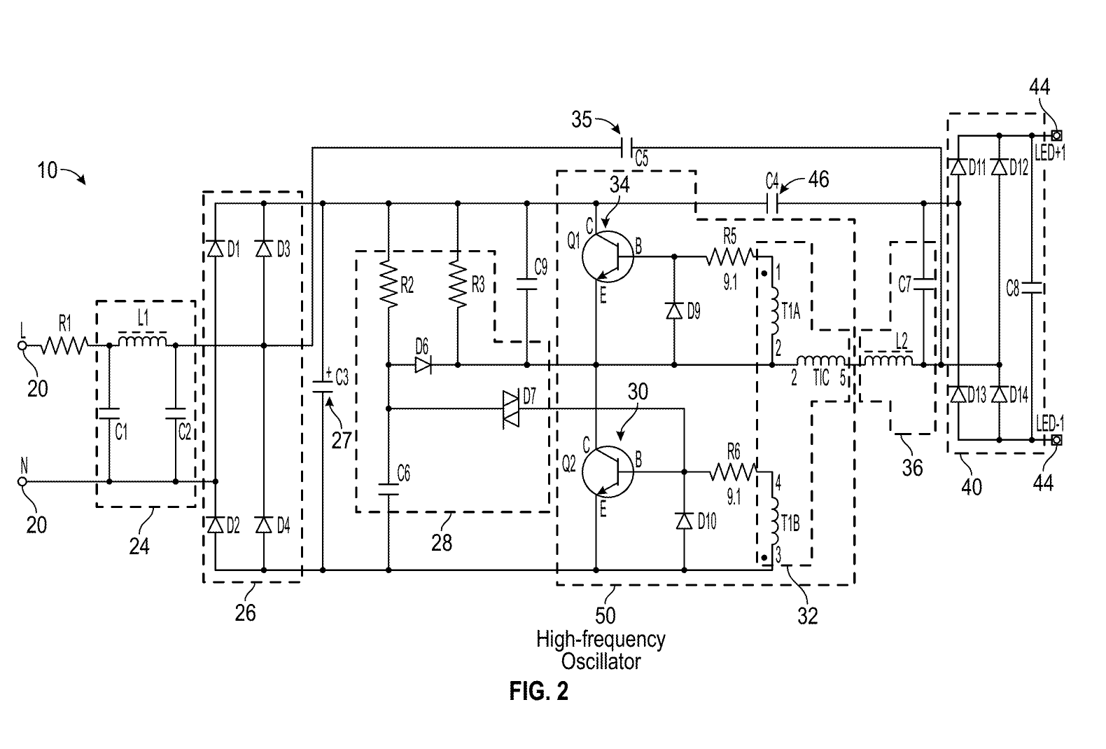

FIG. 1 is an exemplary block diagram of a circuit 10 for providing DC current to a load 18. The driver circuit 10 may include a pair of power input lines 20 for connection to a source (not shown) of AC power such as, for example, main power lines at a nominal 120 volts AC. The driver circuit 10 may also include a resistor R1 (shown in FIG. 2), an electromagnetic interference (EMI) filter 24, a rectifier 26, a voltage bus filter 27, a start-up circuit 28, a switch 30, a transformer 32, a switch 34, a feedback circuit 35, a resonant driver circuit 36, a high-frequency DC rectifier 40, and a blocking capacitor 46. As explained in greater detail below, the circuit 10 provides substantially constant DC current to the load 18, while maintaining a relatively high power factor (PF). In one embodiment, the circuit 10 may include a PF of at least 0.7.

Referring to FIGS. 1-2, the input lines 20 of the driver circuit 10 may be in electrical communication with the EMI filter 24. In one non-limiting embodiment the EMI filter 24 may include an inductor L1 and capacitors C1 and C2 (shown in FIG. 2). The rectifier 26 may be in electrical communication with the EMI filter 24, and is configured to convert incoming AC power from the EMI filter 24 to a pulsing DC power. In the embodiment as shown in FIG. 2, the rectifier 26 is a high-frequency bridge rectifier including four fast recovery diodes D1, D2, D3, D4. In one embodiment, the fast recovery diodes D1-D4 may have a response time of less than about 150 ns, however it is to be understood that this parameter is merely exemplary in nature, and that other types of fast recovery diodes may be used as well.

The output of the rectifier 26 may be in electrical communication with the voltage bus filter 27. In the exemplary embodiment as shown in FIG. 2, the voltage bus filter 27 may include a capacitor C3. Those of ordinary skill in the art will readily appreciate that the capacitor C3 may be an electrolytic capacitor that acts as a smoothing capacitor. Specifically, the capacitor C3 may be used to smoothen or reduce the amount of ripple in the DC power provided by the rectifier 26 such that relatively steady DC power may be provided to the remaining components within the circuit 10 (i.e., the start-up circuit 28, the switch 30, the transformer 32, the switch 34, the resonant driver circuit 36, and the high-frequency DC rectifier 40). As explained in greater detail below, the feedback circuit 35 may be used to create a charge on the capacitor C3. Maintaining a charge on the capacitor C3 further smoothens the DC power provided by the rectifier 26, which in turns improves the PF of the circuit 10.

Continuing to refer to both FIGS. 1 and 2, the voltage bus filter 27 may be in electrical communication with the start-up circuit 28. The start-up circuit 28 may include resistors R2 and R3, diode D6, diac D7, and capacitor C6. The diac D7 is a diode that conducts current only after a breakover voltage, V_{BO}, has been reached. During initial start-up of the circuit 10, the capacitor C6 may be charged until the diac D7 reaches the breakover voltage V_{BO}. Once the breakover voltage is reached, the diac D7 may start to conduct current. Specifically, the diac D7 may be connected to and sends current to the switch 30. Once the diac D7 attains the breakover voltage V_{BO}, the diode D6 may be used to discharge the capacitor C6 and to prevent the diac D7 from firing again.

As seen in FIG. 2, the circuit 10 may include a lower switch 30 (labelled Q2) and an upper switch 34 (labelled Q1) connected in a cascade arrangement. Referring to both FIGS. 1 and 2, the resistor R3 may be used to provide bias to the lower switching element Q2. In the embodiment as shown in FIG. 2, the switching element Q2 is a bipolar junction transistor (BJT). Although a BJT may be a relatively economical and cost-effective component used for switching, those skilled in the art will appreciate that other types of switching elements may be used as well. A diode D10 may be provided to limit negative voltage between a base B and an emitter E of the switching element Q2, which in turn increases efficiency.

The switch 30 may be connected to the transformer 32. As seen in FIG. 2, in an embodiment the transformer 32 includes three windings, T1A, T1B, and T1C. The winding T1A may include an opposite polarity when compared to the winding T1B. This ensures that if the switching element Q2 is turned on, another switching element Q1 will not turn on at the same time.

Referring to FIGS. 1-2, both the switches 30, 32, diodes D9, D10, resistors R5 and R6, and the transformer 32 define a high-frequency oscillator 50. The high-frequency oscillator 50 generates a high-frequency AC signal V_{IN} (shown in FIG. 1). In one embodiment, the high-frequency AC signal V_{IN} may be an AC signal having a frequency of at least about 40 kilohertz (kHz). An output 42 (shown in FIG. 1) of the high-frequency oscillator 50 may be in electrical communication with the resonant driver circuit 36.

Referring to FIG. 2, the upper switching element Q1 may also be a BJT. A diode D9 may be provided to limit negative voltage between a base B and an emitter E of the upper switching element Q1, which in turn increases efficiency. The switch 34 may be used to electrically connect the high-frequency oscillator 50 to the resonant drive circuit 36. In the embodiment as shown in FIG. 2, the resonant drive circuit 36 may include a capacitor C7 connected in series with the winding T1C of the transformer 32. The resonant drive circuit 36 may also include an inductor L2. The resonant drive circuit 36 may be used to limit the current of the high-frequency AC signal V_{IN} received from the high-frequency oscillator 50. The resonant drive circuit 36 also produces a limited output voltage V_{LIMITED} (shown in FIG. 1) based on the high-frequency AC signal V_{IN}.

The resonant driver circuit 36 may be in electrical communication with the high-frequency DC rectifier 40. The limited output voltage V_{LIMITED} created by the resonant driver 36 may be sent to the high-frequency DC rectifier 40, and is rectified into a DC output voltage V_{DC} (shown in FIG. 1). The DC output voltage V_{Dc} includes a substantially constant current that is supplied to the load 18. In the embodiment as shown in FIG. 2, the high-frequency DC rectifier 40 is a full wave rectifier including four diodes D11-D14 and a filter capacitor C8. The full-wave rectifier may be connected in parallel with the filter capacitor C8. In one embodiment, the diodes D11-D14 may be low voltage diodes. It is to be understood that the full wave rectifier 40 doubles the frequency of limited output voltage V_{LIMITED} from the resonant circuit 36, therefore the filter capacitor C8 may be relatively small in size. For example, in one embodiment, the filter capacitor C8 may be less than one microfarad.

Continuing to refer to FIGS. 1-2, the blocking capacitor 46 may include a capacitor C4. The capacitor C4 is in electrical communication with the rectifier 26, the voltage bus filter 27, and the high-frequency DC rectifier 40. The capacitor C4 may be used for impedance matching and for blocking DC current. Specifically, the capacitor C4 allows for the high-frequency AC signal V_{IN} (shown in FIG. 1) generated by the high-frequency oscillator to flow to the high-frequency DC rectifier 40. The capacitor C4 also blocks the DC output voltage V_{DC} generated by the high-frequency DC rectifier 40 located on the right side of the circuit 10 from flowing back to the rectifier 26. In the embodiment as shown in FIG. 2, the blocking capacitor C4 is located between the rectifier 26 and the high-frequency DC rectifier 40. However, in an alternative embodiment, the blocking capacitor 46 may be connected to the emitter E of the switch 30.

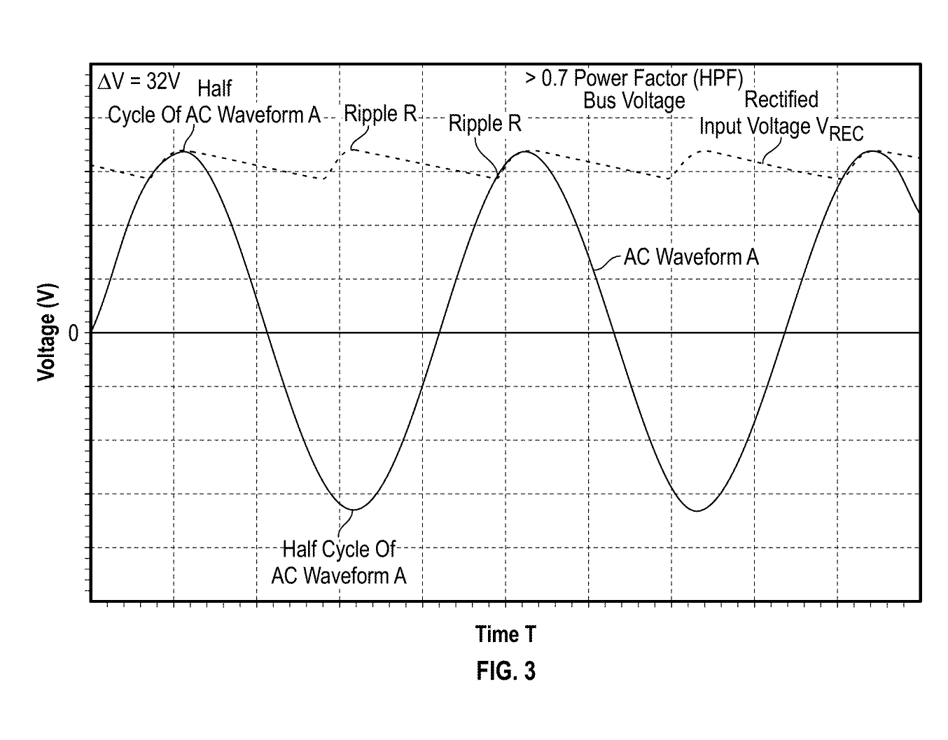

The feedback circuit 35 may be connected to the circuit 10 between the EMI filter 24 and the rectifier 26. The feedback circuit 35 may also be connected to the high-frequency DC rectifier 40. The feedback circuit 35 includes a capacitor C5, which acts as a charge pump that maintains a charge on the capacitor C3 of the voltage bus filter 27, which in turn increases the PF of the circuit 10. Turning now to FIG. 3, an exemplary illustration of an AC waveform A received by the inputs 20 of the circuit 10 is shown. FIG. 3 also illustrates a rectified input voltage V_{REC} of the circuit 10, which is measured after the rectifier 24 at the capacitor C3 of the voltage bus filter 27. The rectified input voltage V_{REC} is based on the AC waveform received by the inputs 20 of the circuit 10.

Referring to both FIGS. 2 and 3, the rectified input voltage V_{REC} includes ripples R. It is to be understood that the amplitude of the ripples R of the rectified input voltage V_{REC} may be reduced due to the feedback circuit 35 maintaining a charge on the capacitor C3 of the voltage bus filter 27. In other words, maintaining a charge on the capacitor C3 will in turn further smoothen or reduce the amount of ripple in the rectified input voltage V_{REC} through each half cycle of the AC waveform A at the inputs 20 of the circuit 10 (the half cycles of the AC waveform A are labelled in FIG. 3). Moreover, maintaining a charge on the capacitor C3 will also result in increased conduction time of the current at the inputs 20 of the circuit 10. Accordingly, the feedback circuit 35 may improve the overall PF of the circuit 10. For example, in one embodiment, the overall PF of the circuit 10 may be at least 0.7.

Turning back to FIG. 2, in one embodiment, the load 18 may be one or more light emitting diodes (LEDs). For example, in embodiments as shown in FIGS. 2-6 the circuit 10 may include a pair of output terminals 44 that connect to a LED (not shown). In the embodiments as described and illustrated in the figures, the driver circuit 10 is used in a non-dimmable LED application. Although an LED is described, it is to be understood that the load 18 may be any type of device that requires a substantially constant current during operation. For example, in an alternative embodiment, the load 18 may be a heating element.

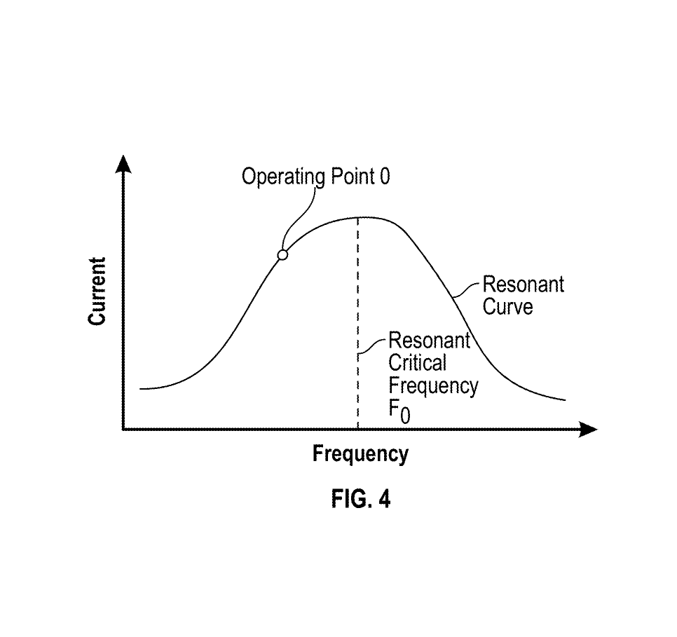

FIG. 4 is an illustration of an exemplary resonance curve of the resonant drive circuit 36 shown in FIG. 2. The resonance curve may include an operating point O and a resonant critical frequency fₒ. The critical frequency fₒ is located at a peak of the resonance curve, and the operating point O is located to the left of the critical frequency fₒ. Referring to both FIGS. 2 and 4, increasing the capacitance of the capacitor C7 or the inductance of the inductor L2 of the resonant driver 36 may shift the critical frequency fₒ to the left, and decrease the capacitance of the capacitor C7 or the inductance of the inductor L2 may shift the critical frequency fₒ to the right. The frequency of oscillation of the resonance curve may be determined by winding T1C of the transformer 32, resistors R5 and R6, the upper switching element Q1, and the lower switching element Q2. In particular, the frequency of oscillation of the resonance curve may be based upon a number of the turns of the winding T1C of the transformer 32, as well as the storage times of the upper switching element Q1 and the lower switching element Q2.

The inductance of the inductor L2 as well as the capacitance of the capacitors C4 and C7 may be key factors in maintaining acceptable line regulation of the circuit 10. Specifically, as line voltage increases a frequency of operation of the circuit 10 decreases. Moreover, the impendence of the inductor L2 may decrease as the frequency of operation decreases, thereby causing an increase in current that is delivered to the load 18 (FIG. 1). Thus, the inductance of the inductor L2 as well as the capacitance of the capacitors C7 and the capacitor C4 may be selected such that an overall gain of the circuit 10 decreases as the frequency of operation decreases. This in turn may substantially decreases or minimize any increase in current that is delivered to the load 18 as the line voltage increases.

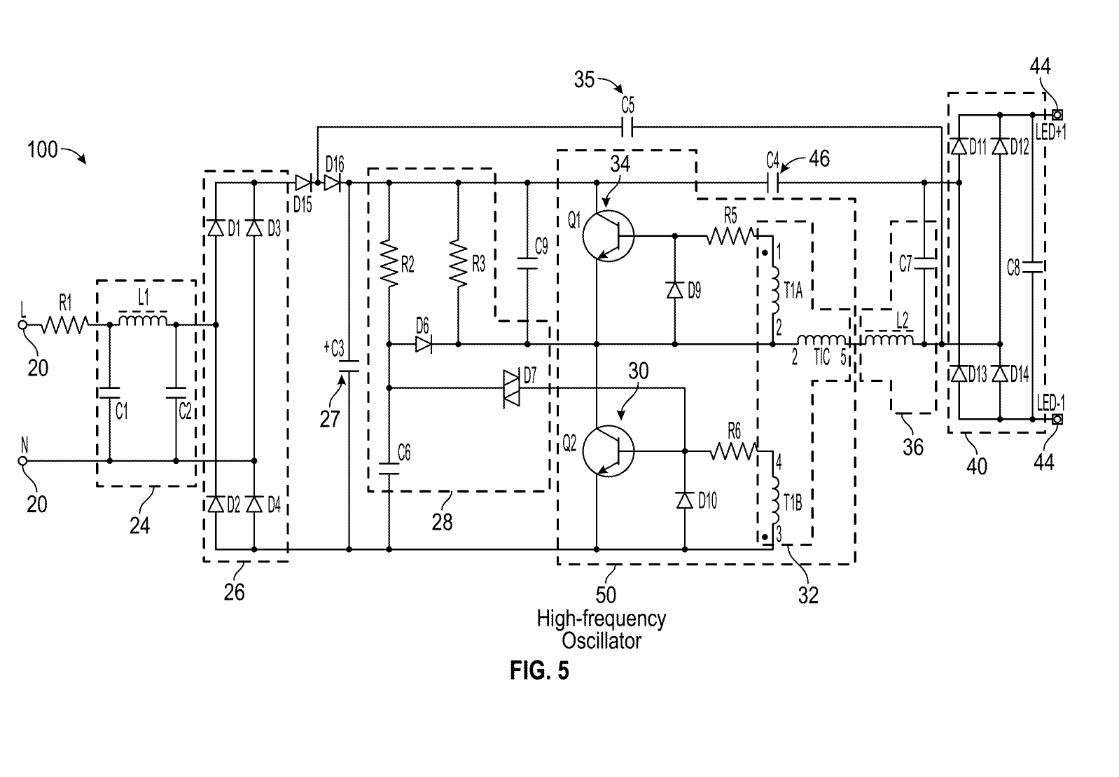

FIG. 5 is an illustration of an alternative circuit 100. The circuit 100 includes similar components as the circuit 10 shown in FIG. 2. However, the circuit 100 also includes two additional diodes D15 and D16 that are located after the rectifier 26. In the embodiment as shown in FIG. 5, the diodes D15, D16 are fast recovery diodes. Diode D15 may be located between the rectifier 26 and diode D16. Diode D16 may be located between diode D15 and the high-frequency DC rectifier 40. Since the circuit 100 includes fast recovery diodes D15 and D15, the diodes D1-D4 of the rectifier 26 do not need to be fast recovery diodes as well. In other words, the rectifier 26 is a standard bridge rectifier. Accordingly, the circuit 100 shown in FIG. 5 may result in a reduced number of fast recovery diodes when compared to the circuit 10 shown in FIG. 10.

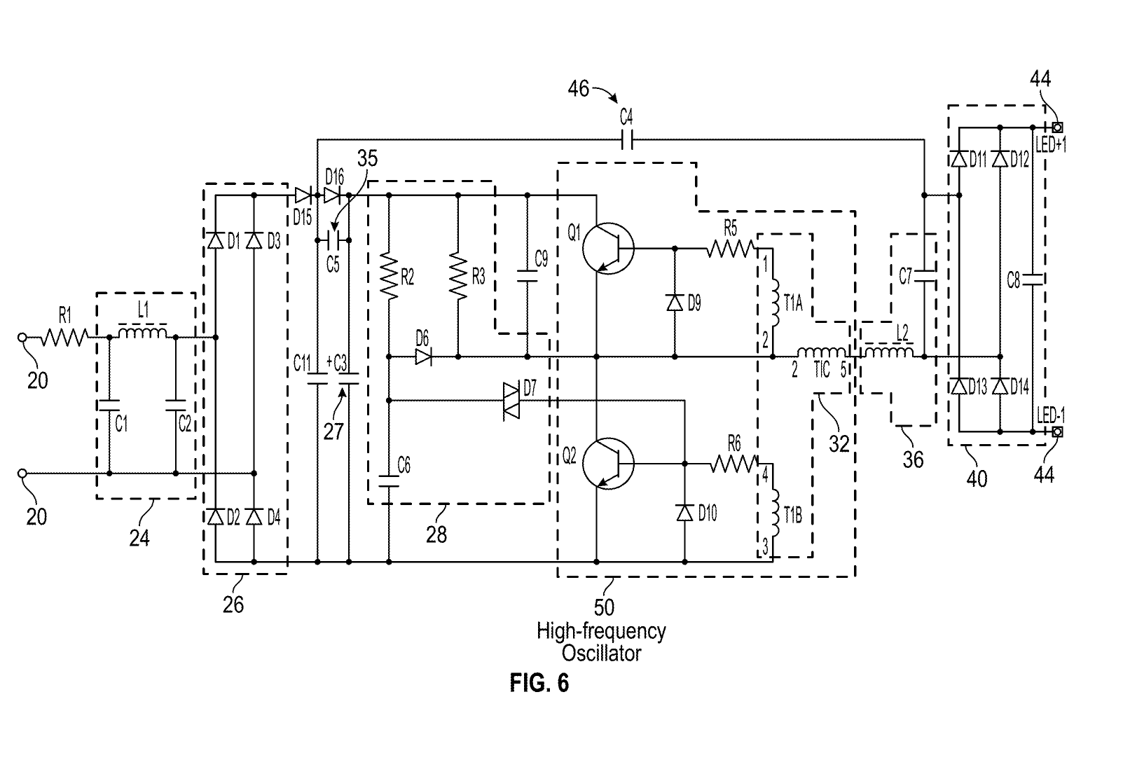

FIG. 6 is yet another embodiment of a circuit 200. The circuit 200 includes similar components as the circuit 100 shown in FIG. 5. However, the location of the blocking capacitor C4 has been modified. Specifically, the blocking capacitor C4 is now connected between diode D15 and the resonant driver circuit 36. Also, the location of the capacitor C5 of the feedback circuit 35 has also been modified. Specifically, the capacitor C5 is now located in parallel with the diode D16. However, capacitor C5 still acts as a charge pump to maintain the charge on the capacitor C3 of the voltage bus filter 27. An additional capacitor C11 has been added to the circuit 200, and is in parallel with the capacitor C3 of the voltage bus filter 27. The capacitor C11 acts as a divider.

The disclosed circuit as illustrated in FIGS. 1-6 and described above provides a relatively low-cost and efficient approach for driving a load, while at the same time providing a relatively high PF (i.e., above 0.7). In particular, the disclosed circuit provides a relatively high PF without the need for active circuitry, which adds cost and complexity to an LED lighting fixture. Furthermore, the disclosed circuit also provides a relatively low-cost and efficient approach for delivering substantially constant current to a load as well. Those skilled in the art will readily appreciate that the disclosed circuit results in fewer components and a simpler design when compared to some types of LED drivers currently available on the market today.

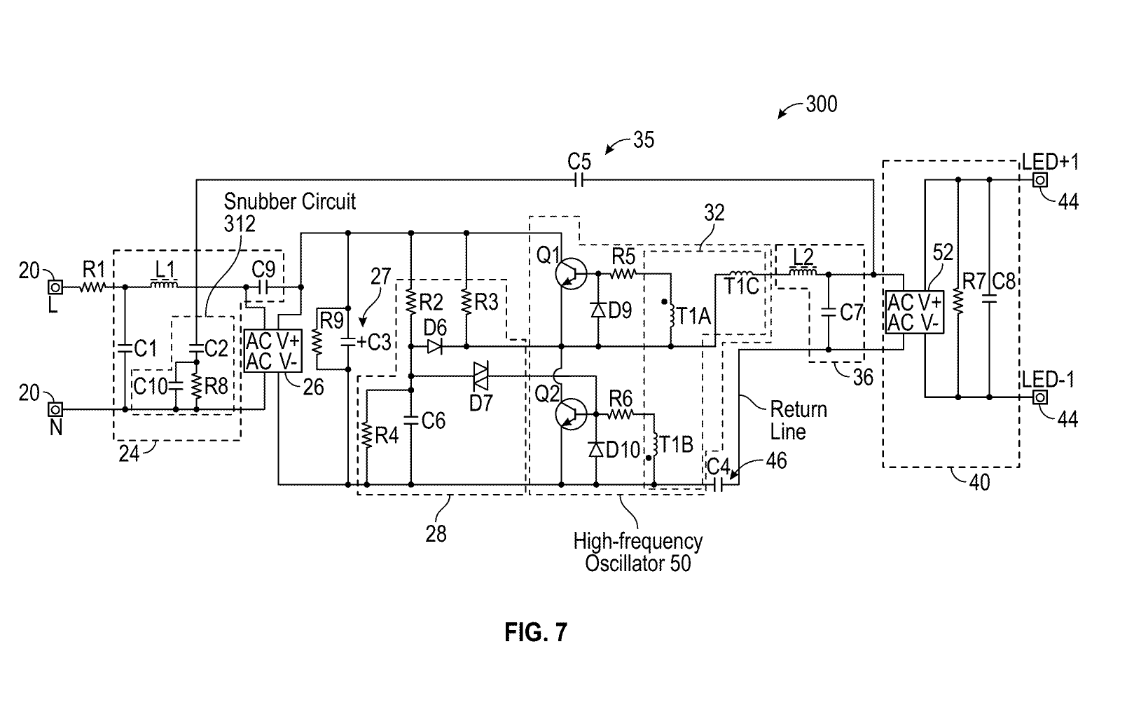

FIG. 7 is an embodiment of a circuit 300 for a dimming application. In particular, the circuit 300 may be used with both leading edge dimmers (which typically use a TRIAC) and reverse phase dimmers (which typically use insulated-gate bipolar transistors or IGBTs). The circuit 300 includes a partially bypassed snubber circuit 312. The disclosed snubber circuit 312 may limit current spikes and voltage transients, thereby substantially preventing premature triggering or shut off of a TRIAC dimmer (not illustrated in the figures). Those of ordinary skill in the art will readily appreciate that a TRIAC dimmer may be electrically connected to the inputs 20 of the circuit 300, and is used to cut out or chop a portion of the AC power, thereby allowing only a portion of the supplied AC power to pass to the inputs 20 of the circuit 300.

Continuing to refer to FIG. 7, the inputs 20 of the circuit 300 receive a dimmed AC signal from either a leading edge dimmer or a reverse phase dimmer (not illustrated). The snubber circuit 312 of the circuit 300 may be electrically connected to the rectifier 26. Similar to the embodiment as shown in FIG. 2, the rectifier 26 of the circuit 300 is a high-frequency bridge rectifier including four fast recovery diodes (not shown in FIG. 7). The EMI filter 24 of the circuit 300 includes the snubber circuit 312 as well as a capacitor C9. The capacitor C9 is connected in parallel with the rectifier 26, and provides additional EMI reduction and limits noise generated by the upper switching element Q1 and the lower switching element Q2. In the embodiment as shown in FIG. 7, the snubber circuit 312 includes only passive elements. In particular, the snubber circuit 312 includes two capacitors C2 and C10 and a resistor R8. The capacitance of capacitor C10 may be about five times less than the capacitance of the capacitor C2 in order to maintain dimming performance of the circuit 300. High frequency noise (i.e., having a frequency greater than 50 kHz) generated by the switches Q1 and Q2 may be shunted through the capacitors C2 and C10.

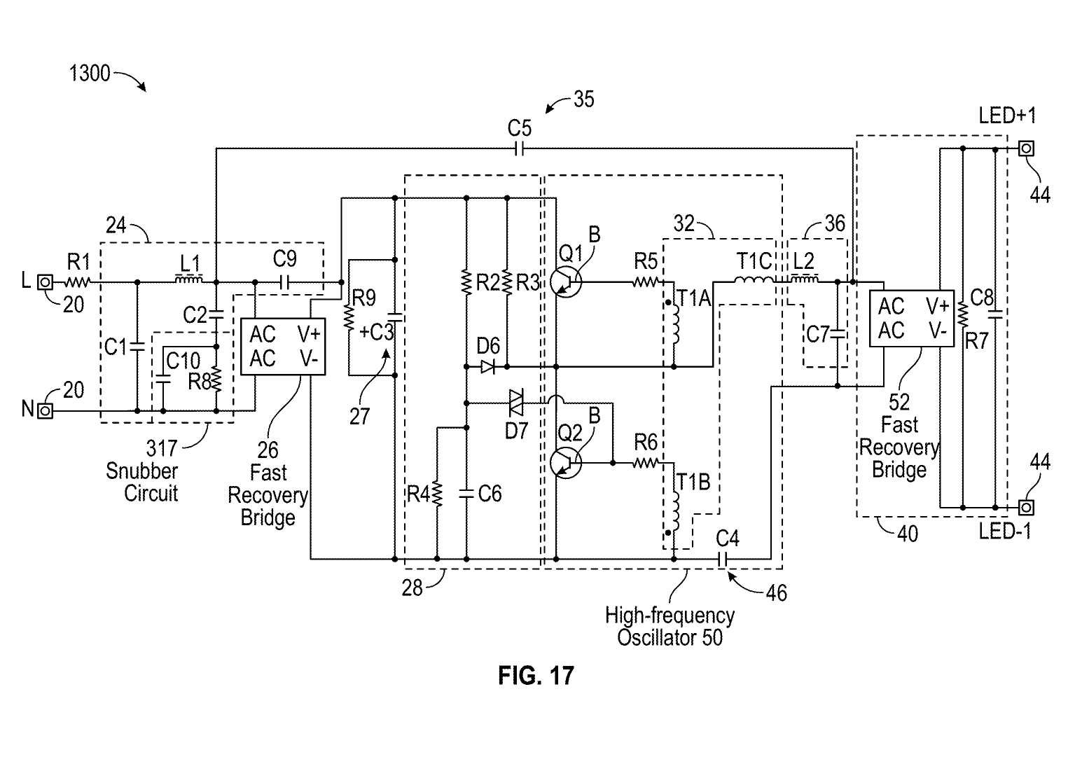

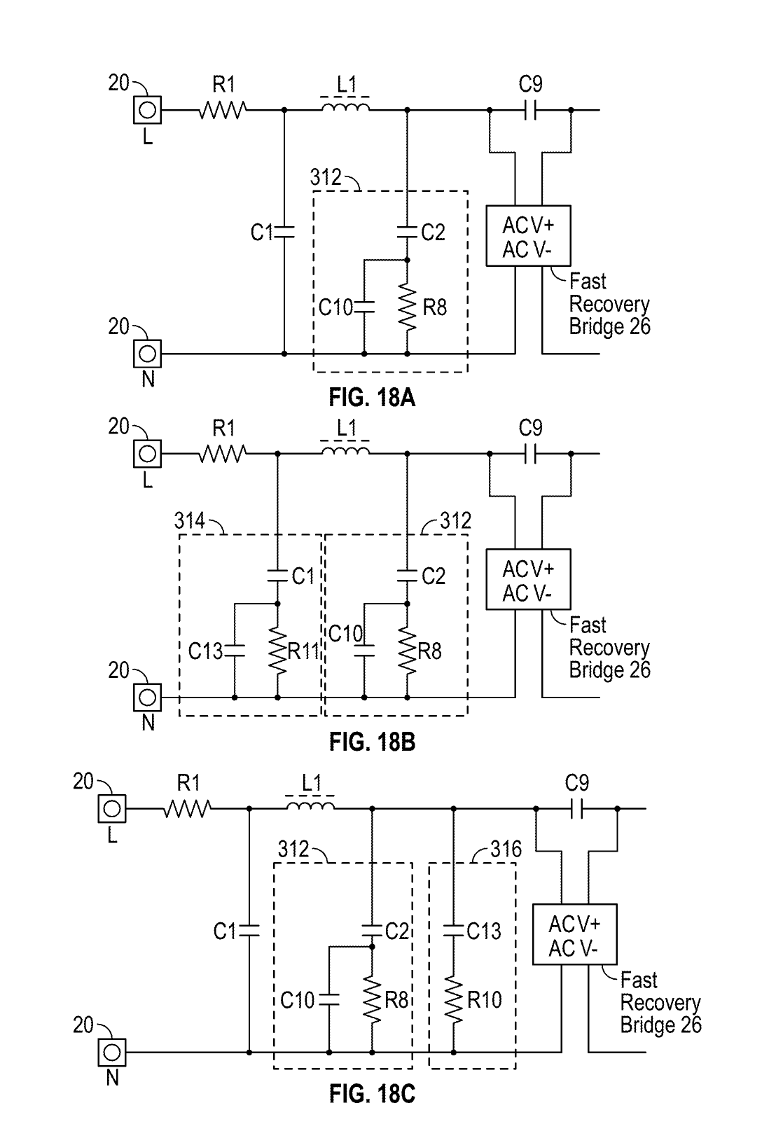

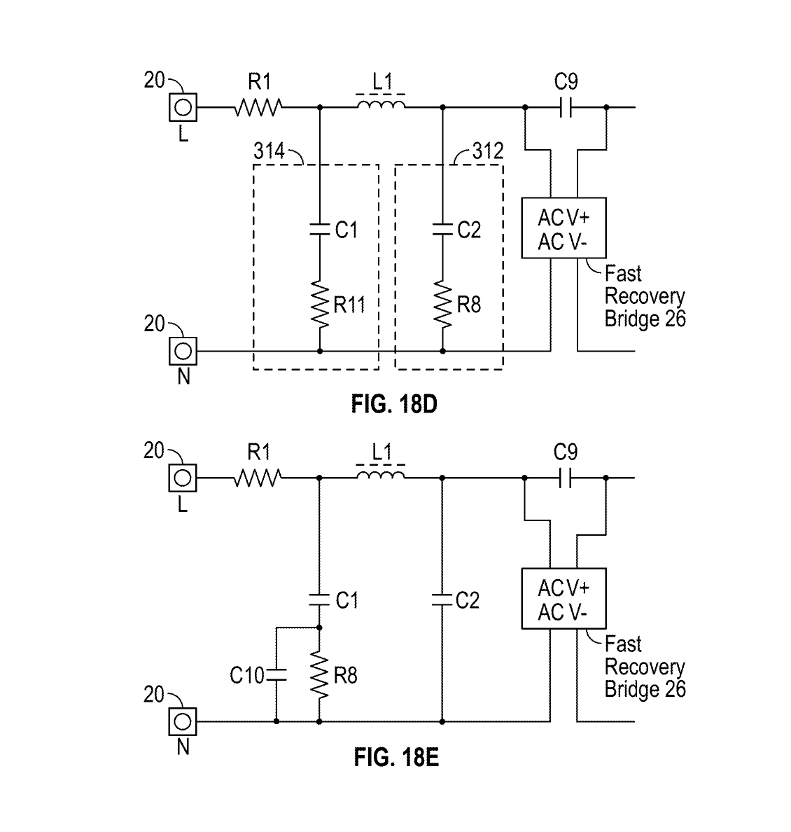

In the non-limiting embodiment as shown in FIG. 7, the capacitor C10 of the snubber circuit 312 is bypass capacitor that is shunted to ground to reduce the EMI generated by the switches Q1 and Q2. However, it is to be understood that the illustration shown in FIG. 7 is merely one embodiment of a snubber circuit. A variety of configurations for the snubber circuit may be used as well. FIGS. 18A-18E illustrate various configurations of the snubber circuit 312, and is described in greater detail below.

It is to be understood that the values for the capacitor C2 and the resistor R8 are chosen to improve the instantaneous rate of voltage change (dV/dt) as well as the instantaneous rate of current change (dI/dt) of a TRIAC dimmer (not illustrated in the figures). Those of ordinary skill in the art will appreciate that a high instantaneous rate of change in voltage over time may potentially cause a TRIAC to falsely trigger on or off. The capacitors C2 and C10 both provide a relatively low impedance (e.g., 100 ohms) with frequencies of 50 kHz or higher, however the resistor R8 provides a relatively constant impedance throughout a range of frequencies. In one exemplary embodiment, the capacitor C2 includes a capacitance of about 220 nF, the capacitor C10 includes a capacitance of about 47 nF, and the value of the resistor R8 is about 820 Ohms. However, the resistance of R8 may vary between 100-2200 Ohms, depending on system wattage.

Continuing to refer to FIG. 7, the capacitor C3 of the voltage bus filter 27 may include a resistor R9 shunted to ground. The resistor R9 may be used as a discharge path to substantially prevent flashing or flickering of the LED during start-up of the circuit 300. The capacitor C6 of the start-up circuit 28 may also include a resistor R4 shunted to ground. The resistor R4 may be used as a discharge path to substantially prevent flashing or flickering of the LED during shut-down of the circuit 300.

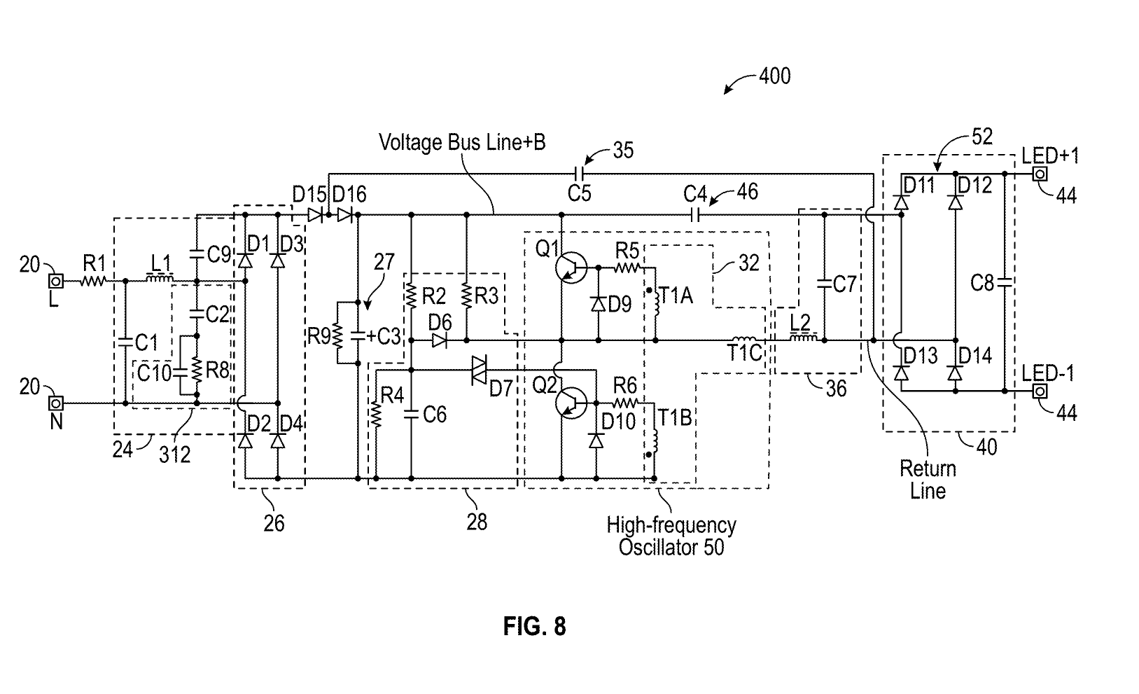

In the embodiment as shown in FIG. 7, the capacitor C4 of the blocking capacitor 46 may be located along a return line of the circuit 300, between the capacitor C7 of the resonant drive circuit 36 and the winding T1B of the transformer 32. It is to be understood that placing the blocking capacitor C4 in the return line of the circuit 300 may improve the dimming performance. However, as seen in FIG. 8, the blocking capacitor 46 may be located between the rectifier 26 and the high-frequency DC rectifier 40, along a voltage bus line +B as well.

The capacitor C5 of the feedback circuit 35 is used to increase the conduction time of the circuit 300. Specifically, the capacitor C5 of the feedback circuit 35 causes the rectifier 26 to continuously draw current from the inputs 20 of the circuit 300. It is to be understood that if the capacitor C5 were omitted from the circuit 300, then the rectifier 26 would only be capable of drawing current at the inputs 20 when the capacitor C3 of the voltage bus filter 27 is charging. However, the addition of the capacitor C5 within the circuit 300 causes the rectifier 26 to continuously draw current from the inputs 20 of the circuit 300, thereby increasing the conduction time of the circuit 300. FIG. 7 also illustrates the capacitor C5 of the feedback circuit 35 connected to the circuit 300 before the rectifier 26. However, it is to be understood that the capacitor C5 may also be connected to the circuit 300 after the rectifier 300, which is illustrated in FIG. 8.

Turning back to FIG. 7, the resonant drive circuit 36 may include the capacitor C7 and the inductor L2, which are connected in series with the winding T1C of the transformer 32. Although FIG. 7 illustrates the capacitor C7, it is to be understood that the capacitor C7 may be omitted from the circuit 300 as well. In other words, the resonant drive circuit 36 may only include the inductor L2.

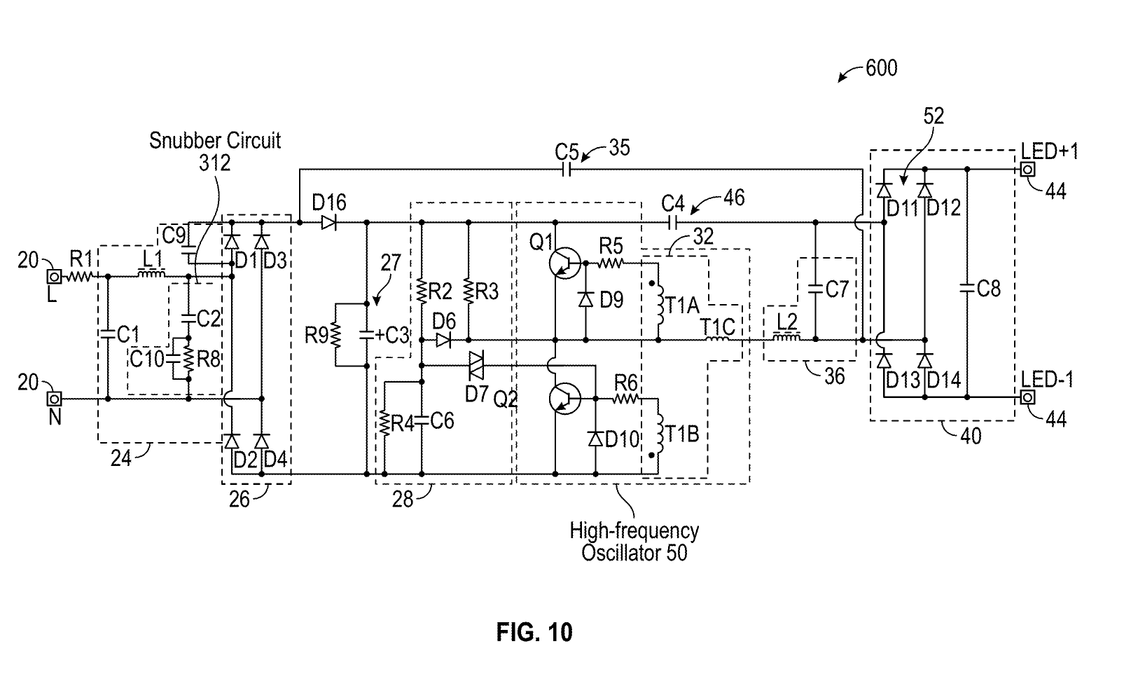

The resonant driver circuit 36 may be in electrical communication with the high-frequency DC rectifier 40. In the embodiment as shown in FIG. 7, the high-frequency DC rectifier includes a full wave rectifier 52 (including four fast recovery diodes that are not illustrated), the filter capacitor C8, and a resistor R7. The full-wave rectifier 52 may be connected in parallel with the filter capacitor C8 and the resistor R7. Although FIG. 7 illustrates the resonant driver circuit 36 including a full wave rectifier 52, it is to be understood that in an alternative embodiment the resonant driver circuit 36 may include a high frequency voltage doubler. A voltage doubler is illustrated in FIG. 11, and is described in greater detail below.

FIG. 8 is another embodiment of a circuit 400 for a dimming application. The circuit 400 includes similar components as the circuit 300 shown in FIG. 7. However, unlike the circuit 300 shown in FIG. 7, the circuit 400 includes two additional fast recovery diodes D15 and D16. Diode D15 may be located between the rectifier 26 and diode D16. Diode D16 may be located between diode D15 and the high-frequency DC rectifier 40. Additionally, unlike the circuit 300 shown in FIG. 7, the four diodes D1, D2, D3, D4 of the rectifier 26 do not need to be fast recovery diodes. Moreover, the capacitor C4 of the blocking capacitor 46 may be located between the rectifier 26 and the high-frequency DC rectifier 40, along the voltage bus line +B. However, it is to be understood that the capacitor C4 may also be placed in the return line of the circuit 400 as well. In the embodiment as shown in FIG. 8, the capacitor C5 is connected to the circuit 400 after the rectifier 26, instead of before the rectifier 26 as seen in FIG. 7. Finally, unlike the circuit 300 shown in FIG. 7, the resistor R7 of the high-frequency DC rectifier 40 has been omitted.

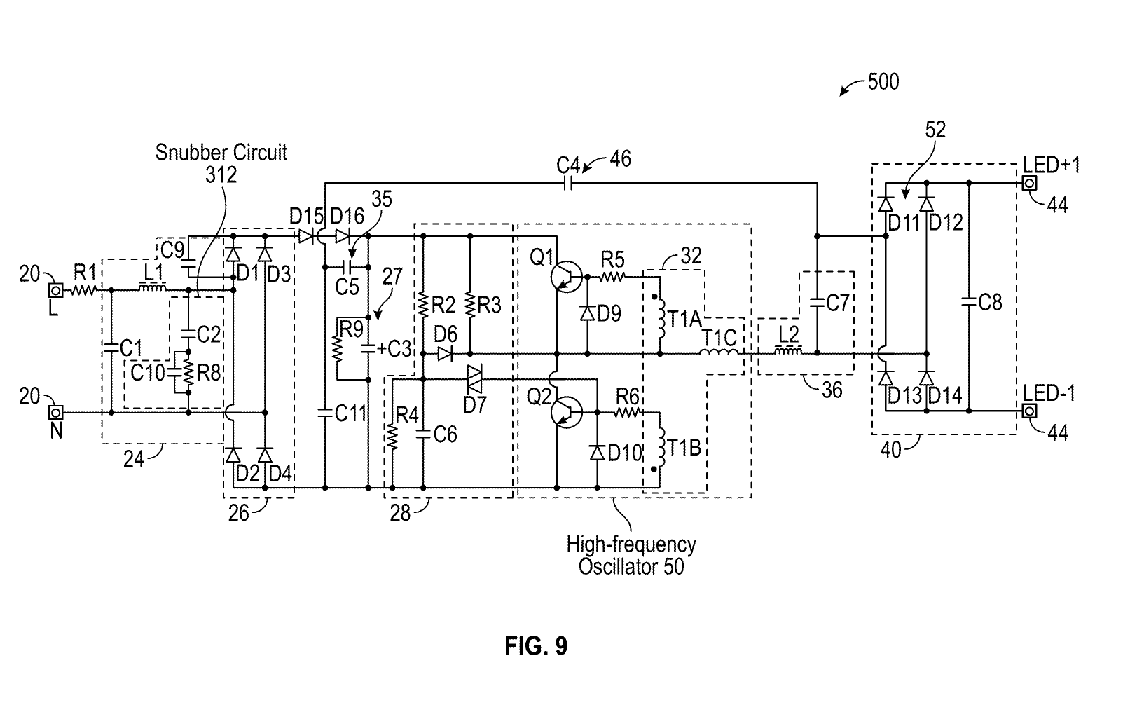

FIG. 9 is yet another embodiment of a circuit 500 for a dimming application. The circuit 500 includes similar components as the circuit 400 shown in FIG. 8. However, the location of the blocking capacitor C4 has been modified. Specifically, the blocking capacitor C4 is now connected to the fast recovery diodes D15 and D16. Also, the location of the capacitor C5 of the feedback circuit 35 has also been modified. Specifically, the capacitor C5 is now located in parallel with the diode D16. However, capacitor C5 still acts as a charge pump to maintain the charge on the capacitor C3 of the voltage bus filter 27. Additionally, the circuit 500 also includes the capacitor C11. The capacitor C11 is in parallel with the capacitor C3 of the voltage bus filter 27. The capacitor C11 acts as a divider.

FIG. 10 is still another embodiment of a circuit 600 for a dimming application. The circuit 600 includes similar components as the circuit 400 shown in FIG. 8. However, unlike the circuit 400 shown in FIG. 8, the circuit 600 only includes diode D16 (i.e., the diode D15 shown in FIG. 8 has been omitted). Because the diode D15 is omitted in the circuit 600, the diodes D1, D2, D3, D4 are fast recovery diodes. It is to be understood that although the capacitor C4 of the blocking capacitor 46 is located between the rectifier 26 and the high-frequency DC rectifier 40, along the voltage bus line +B, the capacitor C4 may also be placed in the return line of the circuit 600 as well.

FIG. 11 is another embodiment of a circuit 700 for a dimming application. The circuit 700 includes similar components as the circuit 300 shown in FIG. 7. Moreover, the capacitor C7 of the resonant drive circuit 36 is connected directly in series with the winding T1C of the transformer 32, and the inductor L2 is located along the return line of the circuit 700. Moreover, unlike the circuit 300 shown in FIG. 7, the high-frequency DC rectifier 40 does not include a full wave rectifier. Instead, the high-frequency DC rectifier 40 includes a high frequency voltage doubler. Specifically, the high frequency voltage doubler may include two fast recovery diodes D11 and D12 and two capacitors C8 and C12 that are arranged in a voltage double (i.e., a voltage multiplier circuit including a voltage multiplication factor of two). The two diodes D11 and D12 of the voltage doubler are both fast recovery diodes.

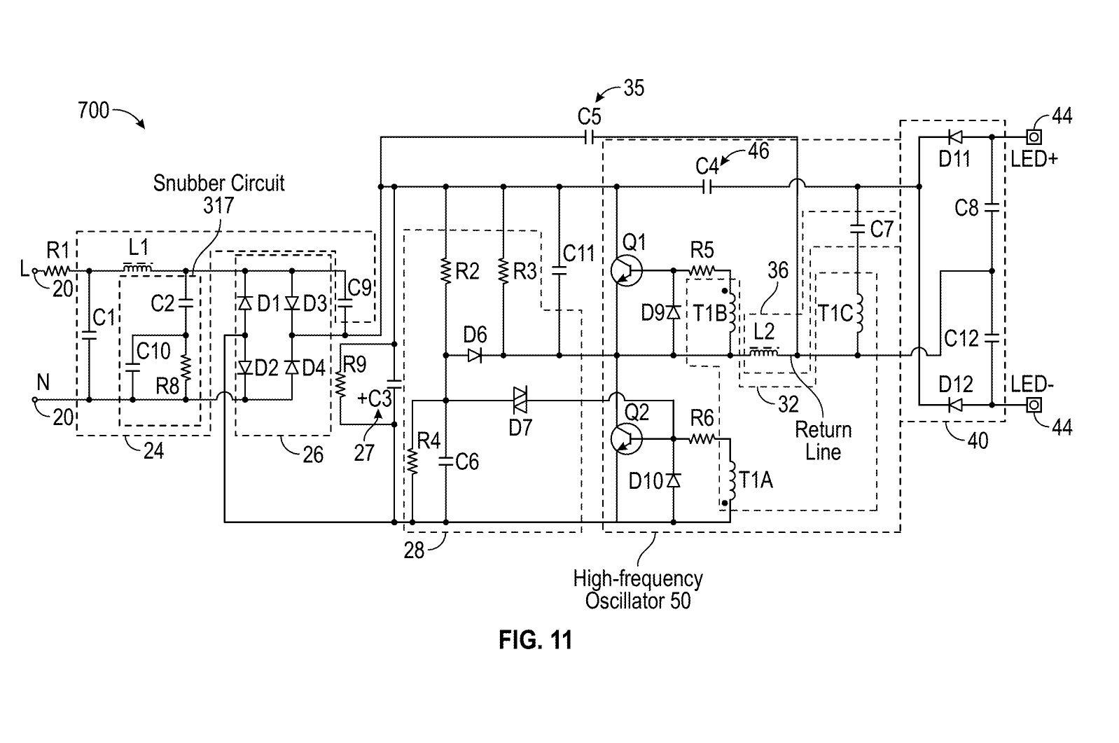

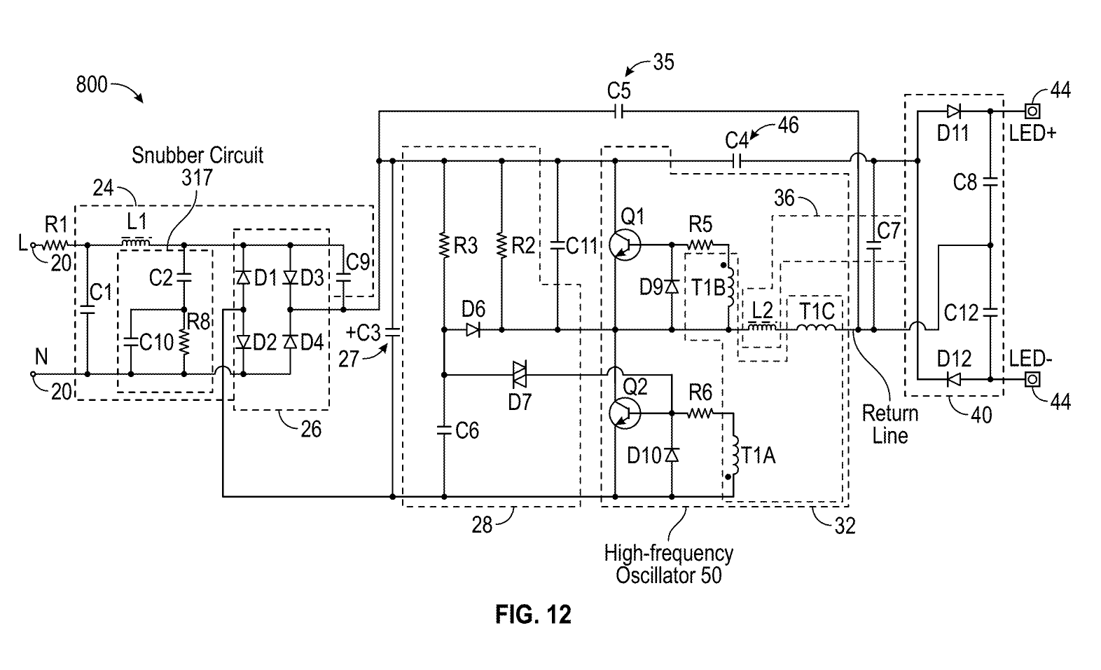

FIG. 12 is yet another embodiment of a circuit 800 for a dimming application. The circuit 800 includes similar components as the circuit 700 shown in FIG. 11. However, unlike the circuit 700 shown in FIG. 11, the inductor L2 of the resonant drive circuit 36 and the winding T1C of the transformer 32 are both located within the return line of the circuit 800. Moreover, unlike the circuit 700 shown in FIG. 11, the resistor R9 connected to the capacitor C3 of the voltage bus filter 27 is omitted. Moreover, the resistor R4 connected to the capacitor C6 of the start-up circuit 28 is also omitted.

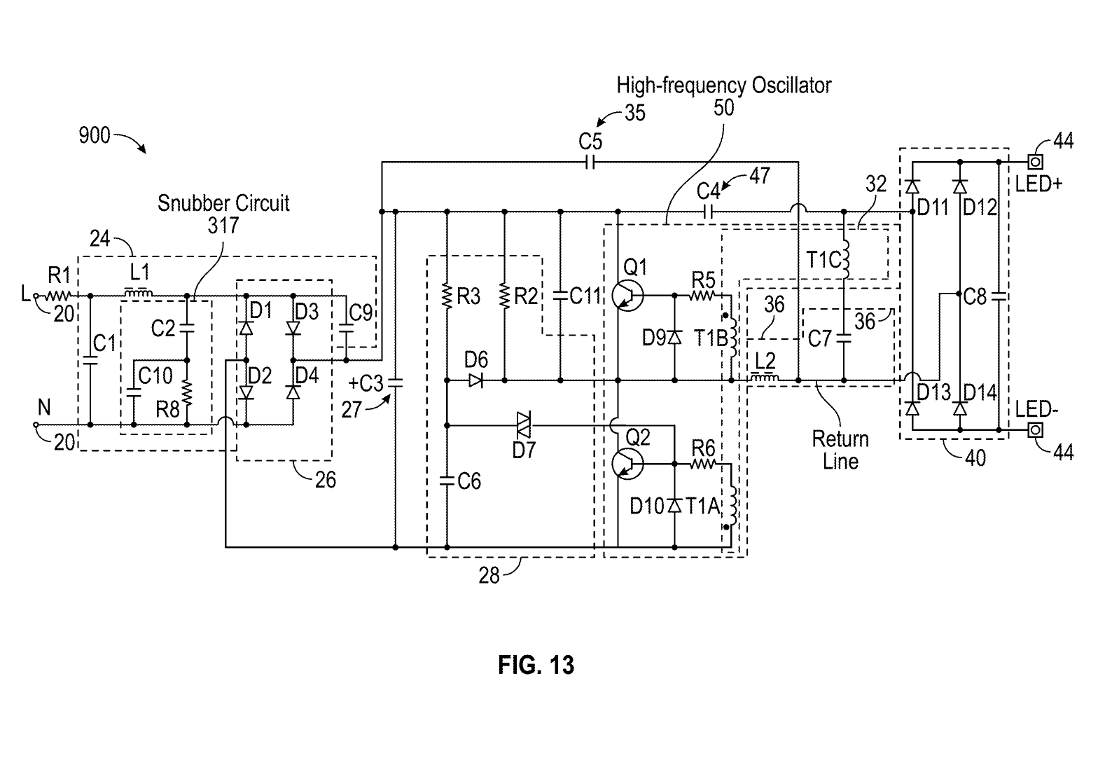

FIG. 13 is another embodiment of a circuit 900 for a dimming application. The circuit 900 includes similar components as the circuit 800 shown in FIG. 12. However, unlike the circuit 800 shown in FIG. 12, the winding T1C of the transformer 32 is no longer located within the return line. Instead, the winding T1C of the circuit 900 is connected in directly in series with the capacitor C7. Moreover, the high-frequency DC rectifier 40 includes a full wave rectifier and the capacitor C8, instead of the voltage doubler shown in FIG. 12.

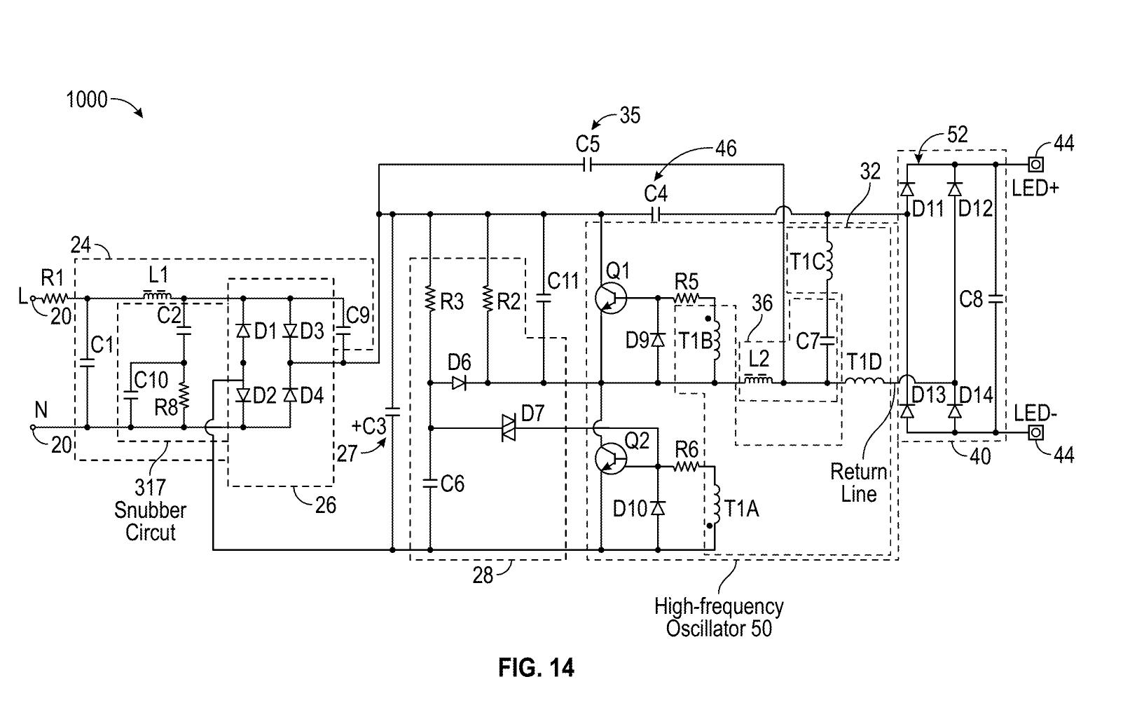

FIG. 14 is yet another embodiment of a circuit 1000 for a dimming application. The circuit 1000 includes similar components as the circuit 900 shown in FIG. 13. However, unlike the circuit 900 shown in FIG. 13, the transformer 32 of the circuit 1000 includes a fourth winding, T1D. The fourth winding T1D is located in the return line of the circuit 1000, between the capacitor C7 of the resonant drive circuit 36 and the full wave rectifier of the high-frequency DC rectifier 40.

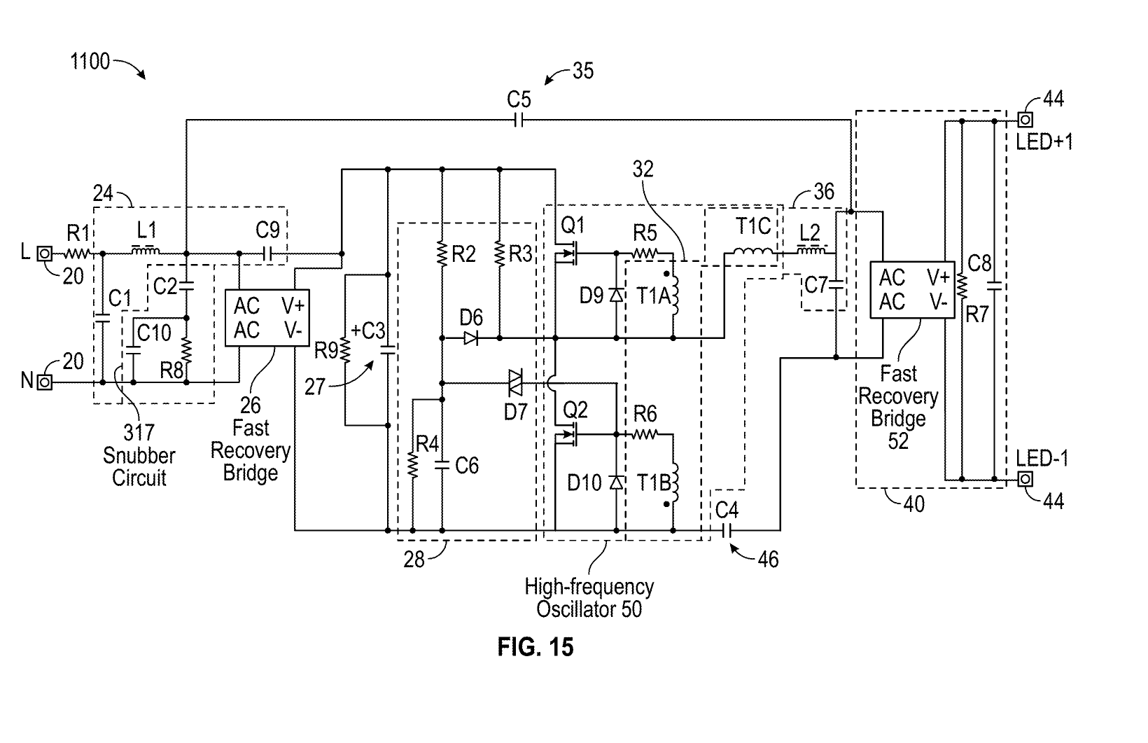

FIG. 15 is another embodiment of a circuit 1100 for a dimming application. The circuit 1100 includes similar components as the circuit 300 shown in FIG. 7. However, unlike the circuit 300 shown in FIG. 7, the upper switching element Q1 and the lower switching element Q2 are both metal oxide semiconductor field-effect transistors (MOSFETs).

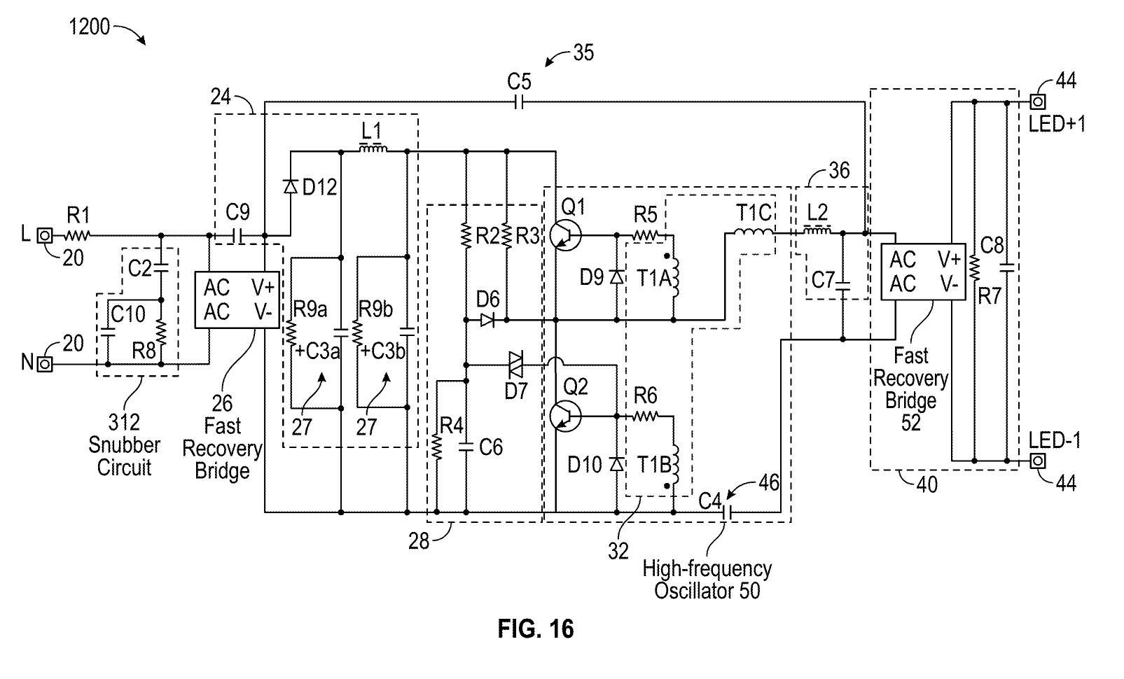

FIG. 16 is still another embodiment of a circuit 1200 for a dimming application. The circuit 1200 includes similar components as the circuit 300 shown in FIG. 7. However, unlike the circuit 300 shown in FIG. 7, the EMI filter 24 is now electrically connected to the circuit 1200 at a location after the rectifier 26. In particular, the inductor L1 of the EMI filter 24 is located after the rectifier 26. A diode D12 has been added to the EMI filter 24, and may be used to maintain a charge on two smoothening capacitors C3a and C3b. Both the smoothening capacitors C3a and C3b have dual functionality. In particular, both the smoothening capacitors C3a and C3b are part of the EMI filter 24, and are also used to smoothen the DC power provided by the rectifier 26. Both smoothening capacitors C3a and C3b each include respective resistors R9a and R9b.

FIG. 17 is yet another embodiment of a circuit 1300 for a dimming application. The circuit 1300 includes similar components as the circuit 300 shown in FIG. 7. However, unlike the circuit 300 shown in FIG. 7, the diode D9 connected to the base B of the upper switching element Q1 has been omitted. Moreover, the diode D10 connected to the base B of the lower switching element Q2 has also been omitted as well.

FIGS. 18A-18E illustrate various embodiments of the snubber circuit 312. In particular, FIG. 13A illustrates the snubber circuit 312 shown in FIGS. 7-17. FIG. 18B is an alternative embodiment, where a second snubber circuit 314 is included. The second snubber circuit 314 includes the capacitor C1, a capacitor C13, and a resistor R11. Similar to the snubber circuit 312, the capacitor C13 is also a bypass capacitor that is shunted to ground to reduce the EMI generated by the switches Q1 and Q2 (shown in FIGS. 7-17). The second snubber circuit 314 may provide additional or enhanced control over dimming, but with the increased cost of additional components. FIG. 18C is yet another embodiment illustrating the snubber circuit 312 and an additional snubber circuit 316. The snubber circuit 316 is located between the snubber circuit 312 and the rectifier 26. The snubber circuit 316 is a conventional or standard snubber including the capacitor C13 connected in series with a resistor R10. FIG. 14 is still another embodiment of including snubber circuit 312 and the second snubber circuit 314. However, unlike the embodiment as shown in FIG. 18B, both the snubber circuits 312, 314 are both standard snubbers. Specifically, the snubber circuit 312 includes the capacitor C2 connected in series with the resistor R8. The second snubber circuit 314 includes the capacitor C1 and the resistor R11. Finally, FIG. 18E is an embodiment of where the snubber circuit 312 has been moved, and is now located between the resistor R1 and the capacitor C2.

Referring generally to FIGS. 7-18E, the disclosed circuits provide a relatively low-cost and efficient approach for dimming an LED, while at the same time providing a relatively high PF (i.e., above 0.7). The disclosed circuits each include a snubber circuit snubber for substantially preventing premature triggering or shut off of a TRIAC dimmer. The disclosed snubber circuit does not include active circuitry that adds cost and complexity to an LED lighting fixture. Finally, the disclosed circuits may also provide enhanced dimming as well as improved EMI performance.

While the forms of apparatus and methods herein described constitute preferred embodiments of this invention, it is to be understood that the invention is not limited to these precise forms of apparatus and methods, and the changes may be made therein without departing from the scope of the invention.

1. A driver circuit for powering at least one light emitting diode (LED) in a dimming application supplying dimmed AC power from a TRIAC dimmer, comprising:
an input for connection to a source of dimmed AC power;
a first rectifier for converting the dimmed AC power from the input into DC power;
a voltage bus filter for smoothening the DC power from the first rectifier, the voltage bus filter including at least one capacitor;
a feedback circuit comprising a feedback capacitor that acts as a charge pump that maintains the charge on the at least one capacitor of the voltage bus filter and causes the first rectifier to continuously draw current from the input of the driver circuit;
a second rectifier for supplying a DC output voltage for powering the LED; and
a snubber circuit in electrical communication with both the first rectifier and the second rectifier, the snubber circuit substantially preventing premature triggering or shut off of the TRIAC dimmer, wherein the snubber circuit includes only passive components.

2. The driver circuit of claim 1, wherein the snubber circuit includes a first capacitor, a second capacitor, and a resistor.

3. The driver circuit of claim 2, wherein the driver circuit further includes a second snubber circuit.

4. The driver circuit of claim 3, wherein the second snubber circuit is a standard snubber circuit including a third capacitor connected in series with a second resistor.

5. The driver circuit of claim 1, wherein the snubber circuit is a standard snubber circuit including a second capacitor connected in series with a resistor.

6. The driver circuit recited in claim 1, wherein the first rectifier is a high-frequency bridge rectifier including four fast recovery diodes.

7. The driver circuit recited in claim 1, comprising a fast recovery diode located after the first rectifier.

8. The driver circuit recited in claim 7, further comprising a second fast recovery diode located after the first rectifier.

9. The driver circuit recited in claim 8, comprising a blocking capacitor in electrical communication with the voltage bus filter, wherein the blocking capacitor is connected between the first fast recovery diode and the second fast recovery diode.

10. The driver circuit recited in claim 8, wherein the feedback capacitor of the feedback circuit is in parallel with the second fast recovery diode.

11. The driver circuit recited in claim 1, comprising a high-frequency oscillator for generating a high-frequency AC signal.

12. The driver circuit recited in claim 11, comprising a resonant driver in electrical communication with the high-frequency oscillator, the resonant driver limiting a current of the high-frequency AC signal and producing a limited output voltage based on the high-frequency AC signal.

13. The driver circuit recited in claim 11, wherein the high-frequency oscillator includes an upper switching element and a lower switching element that are connected in a cascade arrangement.

14. The driver circuit recited in claim 13, wherein the upper switching element and the lower switching element are both bipolar junction transistors (BJTs).

15. The driver circuit recited in claim 14, comprising a first diode connected to a base of the upper switching element and a second diode connected to a base of the lower switching element.

16. The driver circuit recited in claim 13, wherein the upper switching element and the lower switching element are both metal oxide semiconductor field-effect transistors (MOSFETs).

17. The driver circuit recited in claim 1, wherein the first rectifier is a standard bridge rectifier.

18. The driver circuit recited in claim 1, wherein the voltage bus filter includes a resistor shunted to ground.

19. The driver circuit recited in claim 1, comprising a start-up circuit including a diode, a diac, and a capacitor.

20. The driver circuit recited in claim 19, wherein the capacitor of the start-up circuit includes a resistor shunted to ground.

21. The driver circuit recited in claim 1, comprising a blocking capacitor in electrical communication with the voltage bus filter.

22. The driver circuit of claim 21, wherein the blocking capacitor is located along a return line of the driver circuit.

23. The driver circuit of claim 21, wherein the blocking capacitor is located along a voltage bus line of the driver circuit.

24. (canceled)

25. The driver circuit recited in claim 1, wherein the feedback capacitor of the feedback circuit is electrically connected to the driver circuit at a location between the snubber circuit and the second rectifier.

26. The driver circuit recited in claim 1, wherein the feedback capacitor of the feedback circuit is electrically connected to the driver circuit at a location between the first rectifier and the second rectifier.

27. The driver circuit recited in claim 1, comprising an electromagnetic interference (EMI) filter including a capacitor connected in parallel with the first rectifier.

28. The driver circuit recited in claim 1, comprising a transformer including a first winding, a second winding, and a third winding, and wherein the first winding and the second winding include opposite polarities.

29. The driver circuit recited in claim 28, wherein the transformer includes a fourth winding.

30. The driver circuit recited in claim 28, comprising a high-frequency oscillator for generating a high-frequency AC signal and a resonant driver in electrical communication with the high-frequency oscillator, the resonant driver limiting a current of the high-frequency AC signal and producing a limited output voltage based on the high-frequency AC signal.

31. The driver circuit recited in claim 30, wherein the second rectifier is a high-frequency DC rectifier in electrical communication with the resonant driver that rectifies the limited output voltage into the DC output voltage for powering the LED.

32. The driver circuit recited in claim 31, wherein the high-frequency DC rectifier comprises a includes a full wave rectifier including four fast recovery diodes.

33. The driver circuit recited in claim 32, wherein the full wave rectifier is connected in parallel with a filter capacitor.

34. The driver circuit recited in claim 31, wherein the high-frequency DC rectifier comprises a voltage doubler.

35. The driver circuit recited in claim 34, wherein the voltage doubler comprises two fast recovery diodes and two capacitors arranged in a voltage double.

36. The driver circuit recited in claim 30, wherein the resonant drive circuit includes an inductor.

37. The driver circuit recited in claim 36, wherein the resonant drive circuit includes a capacitor.

38. The driver circuit recited in claim 37, wherein the capacitor of the resonant drive circuit is connected in series with the third winding of the transformer, and wherein an inductance of the inductor and a capacitance of the capacitor are selected such that as an overall gain of the driver circuit decreases a frequency of operation also decreases.

39. The driver circuit recited in claim 36, wherein the inductor of the resonant drive circuit is located along a return line of the driver circuit.

40. The driver circuit recited in claim 1, comprising an EMI filter electrically connected to the driver circuit at a location after the first rectifier.

41. The driver circuit recited in claim 40, wherein the EMI filter includes an inductor and a diode.

42. The driver circuit recited in claim 41, wherein the voltage bus filter includes two capacitors, and wherein the diode of the EMI filter maintains a charge on the two capacitors.

43. A driver circuit for powering at least one light emitting diode (LED) in a dimming application supplying dimmed AC power from a TRIAC dimmer, comprising:
an input for connection to a source of dimmed AC power;
a first rectifier for converting the dimmed AC power from the input into DC power;
a voltage bus filter for smoothening the DC power from the first rectifier, the voltage bus filter including at least one capacitor;
a feedback circuit comprising a feedback capacitor that acts as a charge pump that maintains the charge on the at least one capacitor of the voltage bus filter and causes the first rectifier to continuously draw current from the input of the driver circuit; and
a snubber circuit in electrical communication with both the first rectifier and the second rectifier, the snubber circuit substantially preventing premature triggering or shut off of the TRIAC dimmer, wherein the snubber circuit includes only passive components, and wherein the feedback capacitor is electrically connected to the driver circuit at a location between the snubber circuit and the second rectifier.

44. (canceled)

45. The driver circuit recited in claim 43, wherein the first rectifier is a high-frequency bridge rectifier including four fast recovery diodes.

46. The driver circuit recited in claim 43, comprising a blocking capacitor in electrical communication with the voltage bus filter.

47. The driver circuit recited in claim 43, comprising a transformer including a first winding, a second winding, and a third winding, and wherein the first winding and the second winding include opposite polarities.

48. The driver circuit recited in claim 47, comprising a high-frequency oscillator for generating a high-frequency AC signal and a resonant driver in electrical communication with the high-frequency oscillator, the resonant driver limiting a current of the high-frequency AC signal and producing a limited output voltage based on the high-frequency AC signal.

49. The driver circuit recited in claim 48, wherein the second rectifier is a high-frequency DC rectifier in electrical communication with the resonant driver that rectifies the limited output voltage into the DC output voltage for powering the LED.

50. A driver circuit for powering at least one light emitting diode (LED) in a dimming application supplying dimmed AC power from a TRIAC dimmer, comprising:
an input for connection to a source of dimmed AC power;
a first rectifier for converting the dimmed AC power from the input into DC power;
a voltage bus filter for smoothening the DC power from the first rectifier, the voltage bus filter including at least one capacitor;
a feedback circuit comprising a feedback capacitor that acts as a charge pump that maintains the charge on the at least one capacitor of the voltage bus filter and causes the first rectifier to continuously draw current from the input of the driver circuit; and
a snubber circuit in electrical communication with both the first rectifier and the second rectifier, the snubber circuit substantially preventing premature triggering or shut off of the TRIAC dimmer, wherein the snubber circuit includes only passive components, and wherein the feedback capacitor is electrically connected to the driver circuit at a location between the first rectifier and the second rectifier.

51. (canceled)

52. The driver circuit recited in claim 50, wherein the first rectifier is a high-frequency bridge rectifier including four fast recovery diodes.

53. The driver circuit recited in claim 50, comprising a blocking capacitor in electrical communication with the voltage bus filter.

54. The driver circuit recited in claim 50, comprising a transformer including a first winding, a second winding, and a third winding, and wherein the first winding and the second winding include opposite polarities.

55. The driver circuit recited in claim 54, comprising a high-frequency oscillator for generating a high-frequency AC signal and a resonant driver in electrical communication with the high-frequency oscillator, the resonant driver limiting a current of the high-frequency AC signal and producing a limited output voltage based on the high-frequency AC signal.

56. The driver circuit recited in claim 55, wherein the second rectifier is a high-frequency DC rectifier in electrical communication with the resonant driver that rectifies the limited output voltage into the DC output voltage for powering the LED.
